(19) United States
(12) Patent Application Publication
(10) Pub. No.: US 2019/0317270 A1
(43) Pub. Date: Oct. 17, 2019

(54) NEAR-EYE DISPLAY SYSTEM WITH AIR-GAP INTERFERENCE FRINGE MITIGATION

(71) Applicant: Microsoft Technology Licensing, LLC, Redmond, WA (US)

(72) Inventors: Simo Kaarlo Tapani TAMMELA, Espoo (FI); Ari Juhani TERVONEN, Vantaa (FI); Jani Kari Tapio TERVO, Espoo (FI); Lasse Pekka KARVONEN, Espoo (FI)

(21) Appl. No.: 15/954,753

(22) Filed: Apr. 17, 2018

(51) Int. Cl. F21V 8/00; G02B 27/01

(52) U.S. Cl. CPC G02B 6/0076; G02B 27/0172; G02B 6/0026; G02B 2027/0134; G02B 2027/0178; G02B 2027/0123; G02B 6/005

(57) ABSTRACT

A near eye display system includes a waveguide display that presents to the eyes of a viewer mixed-reality or virtual-reality images. The waveguide display includes two or more waveguide plates that are stacked over one another with an air gap between them. The waveguide plates are tilted so that they are not parallel to one another. In this way the spacing or air gap between the waveguide plates varies across the area of the plates. Because of this variation in the size of the air gap interference fringes that would appear in the output image because of constructive and destructive interference between transmitted and reflected light beams are reduced in intensity

### BACKGROUND

Mixed-reality computing devices, such as wearable head mounted display (HMD) systems and mobile devices (e.g. smart phones, tablet computers, etc.), may be configured to display information to a user about virtual and/or real objects in a field of view of the user and/or a field of view of a camera of the device. For example, an HMD device may be configured to display, using a see-through display system, virtual environments with real-world objects mixed in, or real-world environments with virtual objects mixed in.

### SUMMARY

In embodiments, a near eye display system includes a waveguide display that presents to the eyes of a viewer mixed-reality or virtual-reality images. The waveguide display includes two or more waveguide plates that are stacked over one another with an air gap between them. The waveguide plates are tilted so that they are not parallel to one another. In this way the spacing or air gap between the waveguide plates varies along the length of the plates. Because of this variation in the size of the air gap interference fringes that would appear in the output image because of constructive and destructive interference between transmitted and reflected light beams are reduced in intensity.

In certain embodiments each of the waveguide plates in the stack is used to transfer different wavelengths or colors of light to the viewer. The waveguide plates each include a transparent substrate and input and output couplers such as diffractive optical elements (DOEs) for coupling light into and out of the waveguide substrates, respectively.

In certain embodiments the near eye display system may be incorporated in a head mounted display (HMD). The HMD includes a head mounted retention system for wearing on a head of a user and a visor assembly secured to the head mounted retention system. The near eye display system may be secured to a chassis of visor system so that when the placed on the head of the user the near eye display system is situated in front of the user's eyes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows a block diagram of an illustrative near-eye optical display system.

FIG. 2 shows a view of an illustrative exit pupil expander.

FIG. 3 shows a view of an illustrative exit pupil expander (EPE) in which the exit pupil is expanded along two directions.

FIG. 4 shows an illustrative input to an exit pupil expander in which the FOV is described by angles in horizontal, vertical, or diagonal orientations.

FIG. 5 shows a pictorial front view of a sealed visor that may be used as a component of a head mounted display (HMD) device.

FIG. 6 shows a partially disassembled view of the sealed visor.

FIG. 7 shows an alternative example of an EPE in which a stack of two or more waveguide plates are employed.

FIG. 8 illustrates the operation of the EPE shown in FIG. 7.

FIG. 9 shows two waveguide plates to illustrate how interference fringes are produced as a result of interference between light beams that undergo reflection in the air gap and those that do not undergo reflection.

FIG. 10 show two stacked waveguide plates that are parallel to one another.

FIG. 11 show two stacked waveguide plates that are not parallel to one another.

FIG. 12 shows an illustrative example of a mixed-reality or virtual-reality HMD device.

FIG. 13 shows a functional block diagram of the mixed-reality or virtual-reality HMD device shown in FIG. 12.

Like reference numerals indicate like elements in the drawings. Elements are not drawn to scale unless otherwise indicated.

### DETAILED DESCRIPTION

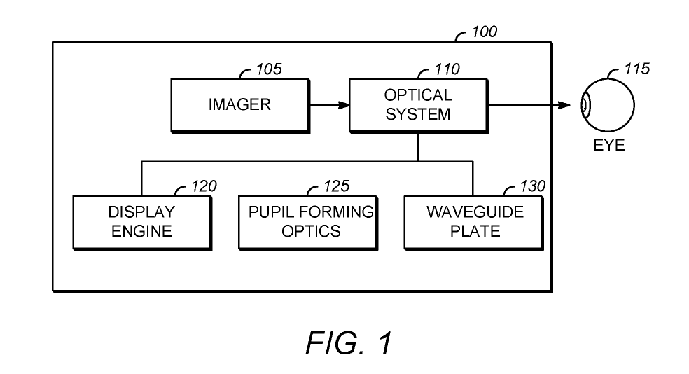

FIG. 1 shows a block diagram of an illustrative near-eye optical display system 100 which may incorporate a combination of optical couplers such as diffractive optical elements (DOEs) that provide in-coupling of incident light into a waveguide plate, exit pupil expansion in two directions, and out-coupling of light out of the waveguide plate. Near-eye optical display systems are often used, for example, in head mounted display (HMD) devices in industrial, commercial, and consumer applications. Other devices and systems may also use near-eye display systems, as described below. The near-eye optical display system 100 is an example that is used to provide context and illustrate various features and aspects of the present compact display engine with MEMS scanners.

System 100 may include one or more imagers (representatively indicated by reference numeral 105) that work with an optical system 110 to deliver images as a virtual display to a user's eye 115. The imager 105 may include, for example, RGB (red, green, blue) light emitting diodes (LEDs), LCOS (liquid crystal on silicon) devices, OLED (organic light emitting diode) arrays, lasers, laser diodes, or any other suitable displays or micro-displays operating in transmission, reflection, or emission. The optical system 110 can typically include a display engine 120, pupil forming optics 125, and one or more waveguide plates 130. The imager 105 may include or incorporate an illumination unit and/or light engine (not shown) that may be configured to provide illumination in a range of wavelengths and intensities in some implementations.

In a near-eye optical display system the imager 105 does not actually shine the images on a surface such as a glass lens to create the visual display for the user. This is not feasible because the human eye cannot focus on something that is that close. Rather than create a visible image on a surface, the near-eye optical display system 100 uses the pupil forming optics 125 to form a pupil and the eye 115 acts as the last element in the optical chain and converts the light from the pupil into an image on the eye's retina as a virtual display.

The waveguide plate 130 facilitates light transmission between the imager and the eye. One or more waveguide plates can be utilized in the near-eye optical display system because they are transparent and because they are generally small and lightweight (which is desirable in applications such as HMD devices where size and weight is generally sought to be minimized for reasons of performance and user comfort). For example, the waveguide plate 130 can enable the imager 105 to be located out of the way, for example, on the side of the user's head or near the forehead, leaving only a relatively small, light, and transparent waveguide optical element in front of the eyes. The waveguide plate 130 operates using a principle of total internal reflection (TIR).

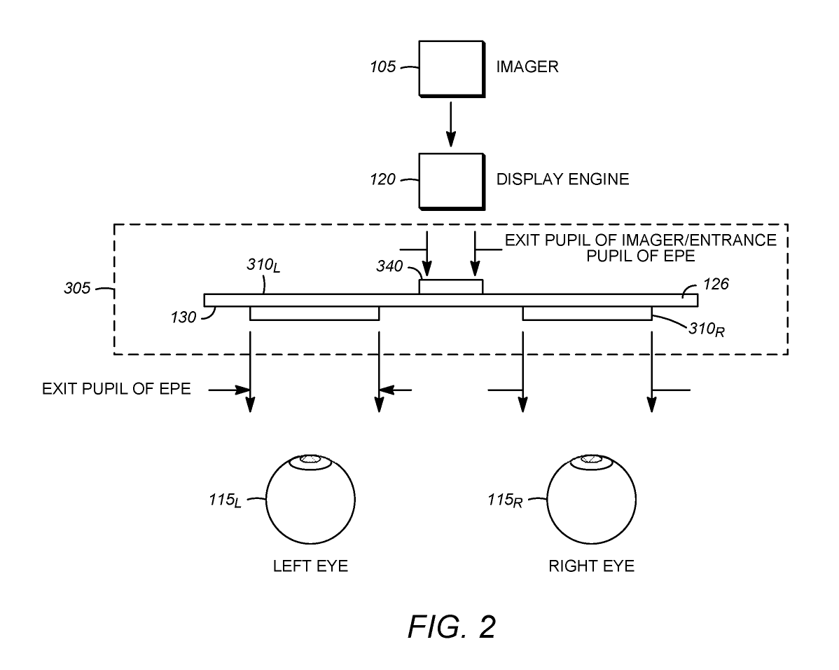

FIG. 2 shows a view of an illustrative exit pupil expander (EPE) 305 that may be used in the pupil forming optics 125 shown in FIG. 1. EPE 305 receives an input optical beam from the imager 105 and the display engine 120 as an entrance pupil to produce one or more output optical beams with expanded exit pupil in one or two directions relative to the input (in general, the input may include more than one optical beam which may be produced by separate sources). The display engine replaces magnifying and/or collimating optics that are typically used in conventional display systems. The expanded exit pupil typically facilitates a virtual display to be sufficiently sized to meet the various design requirements such as image resolution, field of view, and the like of a given optical system while enabling the imager and associated components to be relatively light and compact.

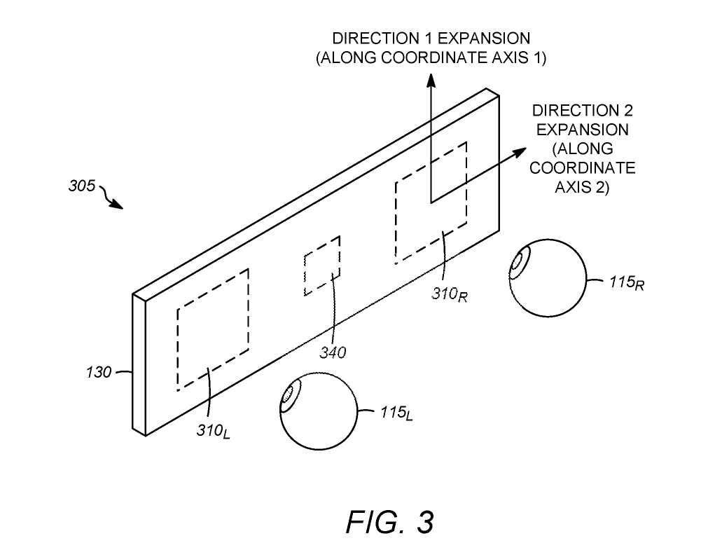

The EPE 305 is configured, in this illustrative example, to provide binocular operation for both the left and right eyes which may support stereoscopic viewing. Components that may be utilized for stereoscopic operation such as scanning mirrors, lenses, filters, beam splitters, MEMS devices, or the like are not shown in FIG. 3 for sake of clarity in exposition. The EPE 305 utilizes a waveguide display with a waveguide plate 130 that includes a transparent substrate 126, two out-coupling gratings, 310_{L} and 310_{R} and a central in-coupling grating 340 that are supported on or in the substrate 126. The substrate 126 may be made, for instance, from glass or plastic. The in-coupling and out-coupling gratings may be configured using multiple DOEs. Each DOE is an optical element comprising a periodic structure that can modulate various properties of light in a periodic pattern such as the direction of optical axis, optical path length, and the like. The structure can be periodic in one dimension such as one-dimensional (1D) grating and/or be periodic in two dimensions such as two-dimensional (2D) grating, While the waveguide plate 130 is depicted as having a planar configuration, other shapes may also be utilized including, for example, curved or partially spherical shapes, in which case the gratings disposed thereon are non-co-planar.

While the illustrative EPE 305 shown in FIG. 3 employs a single waveguide plate for binocular operation, in other examples a separate waveguide plate may be used for each eye. In this case each waveguide plate may have its own coupling gratings, imager and display engine.

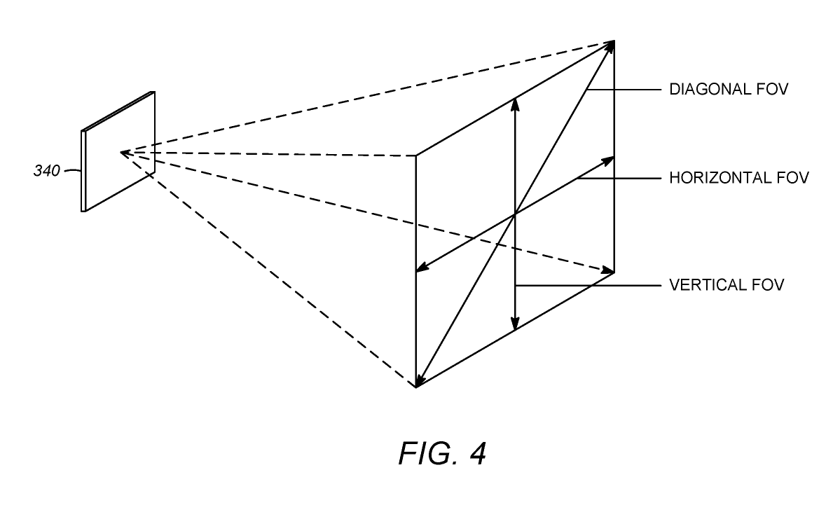

As shown in FIG. 3, the EPE 305 may be configured to provide an expanded exit pupil in two directions (i.e., along each of a first and second coordinate axis). As shown, the exit pupil is expanded in both the vertical and horizontal directions. It may be understood that the terms “left,” “right,” “up,” “down,” “direction,” “horizontal,” and “vertical” are used primarily to establish relative orientations in the illustrative examples shown and described herein for ease of description. These terms may be intuitive for a usage scenario in which the user of the near-eye optical display device is upright and forward facing, but less intuitive for other usage scenarios. The listed terms are not to be construed to limit the scope of the configurations (and usage scenarios therein) of near-eye optical display features utilized in the present arrangement. The entrance pupil to the EPE 305 at the in-coupling grating 340 is generally described in terms of field of view (FOV), for example, using horizontal FOV, vertical FOV, or diagonal FOV as shown in FIG. 4.

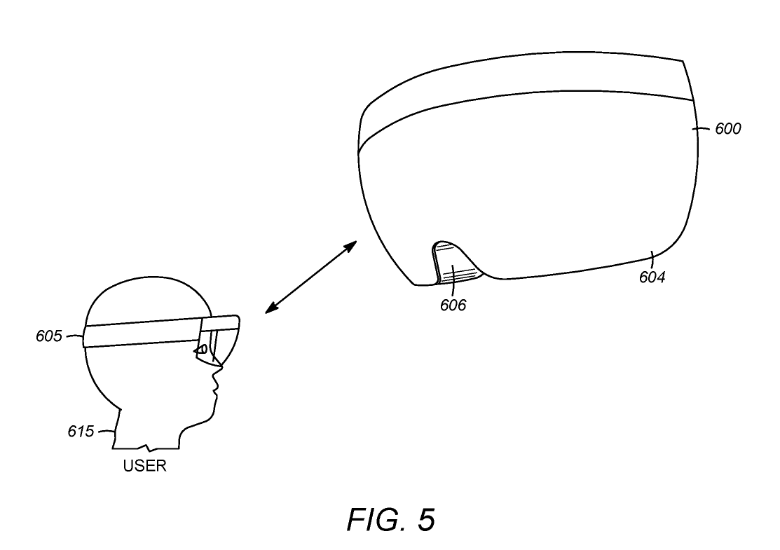

FIG. 5 shows an illustrative example of a visor 600 that incorporates an internal near-eye optical display system that is used in a head mounted display (HMD) device 605 application worn by a user 615. The visor 600, in this example, is sealed to protect the internal near-eye optical display system. The visor 600 typically interfaces with other components of the HMD device 605 such as head mounting/retention systems and other subsystems including sensors, power management, controllers, etc., as illustratively described in conjunction with FIGS. 14 and 15. Suitable interface elements (not shown) including snaps, bosses, screws and other fasteners, etc. may also be incorporated into the visor 600.

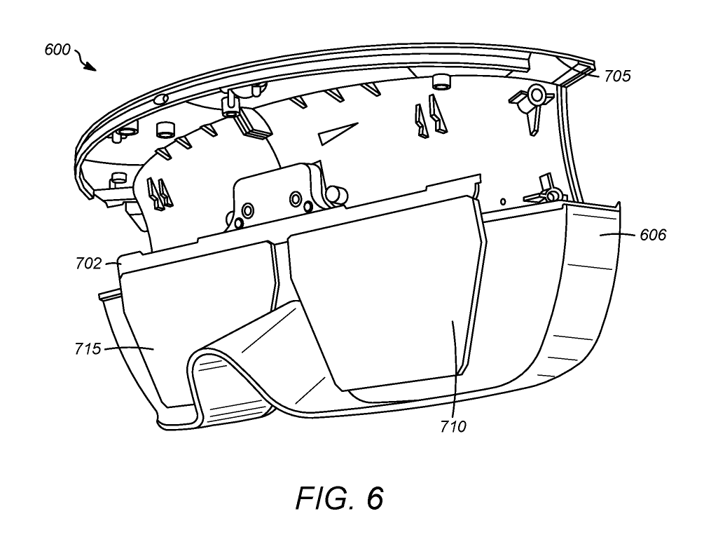

The visor 600 includes see-through front and rear shields, 604 and 606 respectively, that can be molded using transparent materials to facilitate unobstructed vision to the optical displays and the surrounding real world environment. Treatments may be applied to the front and rear shields such as tinting, mirroring, anti-reflective, anti-fog, and other coatings, and various colors and finishes may also be utilized. The front and rear shields are affixed to a chassis 705 shown in the disassembled view in FIG. 6.

The sealed visor 600 can physically protect sensitive internal components, including a near-eye optical display system 702 (shown in FIG. 6), when the HMD device is used in operation and during normal handling for cleaning and the like. The near-eye optical display system 702 includes left and right waveguide displays 710 and 715 that respectively provide virtual world images to the user's left and right eyes for mixed- and/or virtual-reality applications. The visor 600 can also protect the near-eye optical display system 702 from environmental elements and damage should the HMD device be dropped or bumped, impacted, etc.

As shown in FIG. 6, the rear shield 606 is configured in an ergonomically suitable form to interface with the user's nose, and nose pads and/or other comfort features can be included (e.g., molded-in and/or added-on as discrete components). The sealed visor 600 can also incorporate some level of optical diopter curvature (i.e., eye prescription) within the molded shields in some cases.

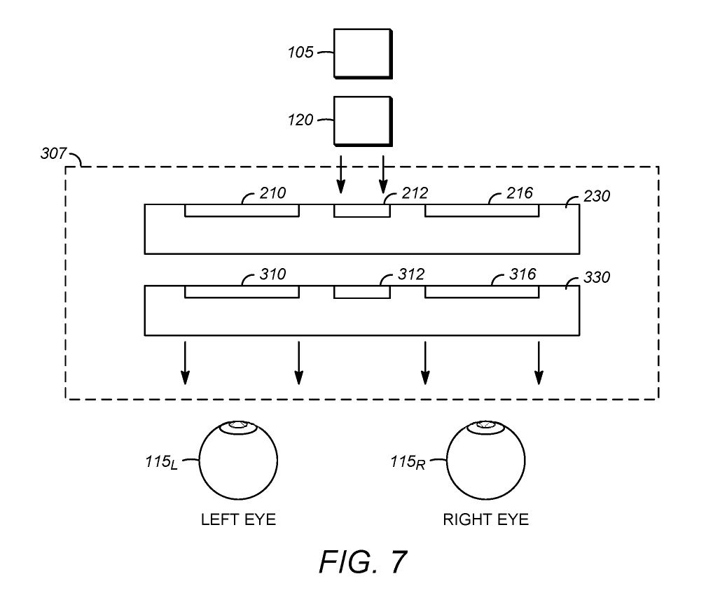

FIG. 7 shows an alternative example of an EPE 307 in which a waveguide display includes a stack of two or more waveguide plates are employed instead of the single waveguide plate shown in the EPE 305 of FIG. 3. In this example each waveguide plate, which each may be of the type described above in connection with FIG. 3, can be used to transfer different optical wavelengths or colors of an image. For instance, in the particular example of FIG. 7, waveguide plate 230 may be used to transmit wavelengths corresponding to the red portion of an image and waveguide plate 330 may be used to transmit wavelengths corresponding to the blue and green portions of the image. The use of a waveguide stack instead of a single waveguide plate addresses the problem that may arise because the optical path lengths within the waveguide plates differ for different wavelengths of light, which can adversely impact the uniform distribution of light. In accordance with an embodiment, the red wavelength range is from 600 nm to 650 nm, the green wavelength range is from 500 nm to 550 nm, and the blue wavelength range is from 430 nm to 480 nm. Other wavelength ranges are also possible.

More specifically, an input coupler 212 of the waveguide 230 can be configured to couple light (corresponding to the image) within the red wavelength range into the waveguide 230, and the output couplers 210 and 216 of the waveguide 230 can be configured to couple light (corresponding to the image) within the red wavelength range (which has travelled from the input coupler 212 to the output couplers 210 and 216 by way of TIR) out of the waveguide 230. Similarly, an input coupler 312 of the waveguide 330 can be configured to couple light (corresponding to the image) within the blue and green wavelength ranges into the waveguide 330, and the output couplers 310 and 316 of the waveguide 330 can be configured to couple light (corresponding to the image) within the blue and green wavelength ranges (which has travelled from the input coupler 312 to the output couplers 310 and 316 by way of TIR) out of the waveguide 330.

FIG. 7 also shows left and right eyes 115L and 115R. The left eye 115L is viewing the image (as a virtual image) that is proximate to the output couplers 210 and 310 and the right eye 155R is viewing the image (as a virtual image) that is proximate to the output couplers 230 and 330. Explained another way, the eyes 115L and 115R are viewing the image from an exit pupil associated with the waveguides 230 and 330.

The distance between adjacent waveguides 230 and 330 can be, e.g., between approximately 50 micrometers and 300 micrometers, but is not limited thereto. While not specifically shown, spacers can be located between adjacent waveguides to maintain a desired spacing therebetween.

In other examples of the EPE, the number of waveguide plates in the stack of waveguide plates may vary, with each waveguide plate transmitting a different range of wavelengths or colors. For instance, if three waveguide plates are employed, one may be configured to transmit wavelengths corresponding to red light, another may be configured to transmit wavelengths corresponding to green light and the third waveguide plate may be configured to transmit wavelengths corresponding to blue light. Of course, other combinations of waveguide plates and wavelengths or colors of light may also be employed. Additionally, the wavelength ranges transmitted by each waveguide plate may be different and nonoverlapping from every other plate (as in the examples mentioned above), or, alternatively, the waveguide ranges may overlap for two or more of the waveguide plates. Moreover, the order in which the waveguide plates are stacked may differ in different examples.

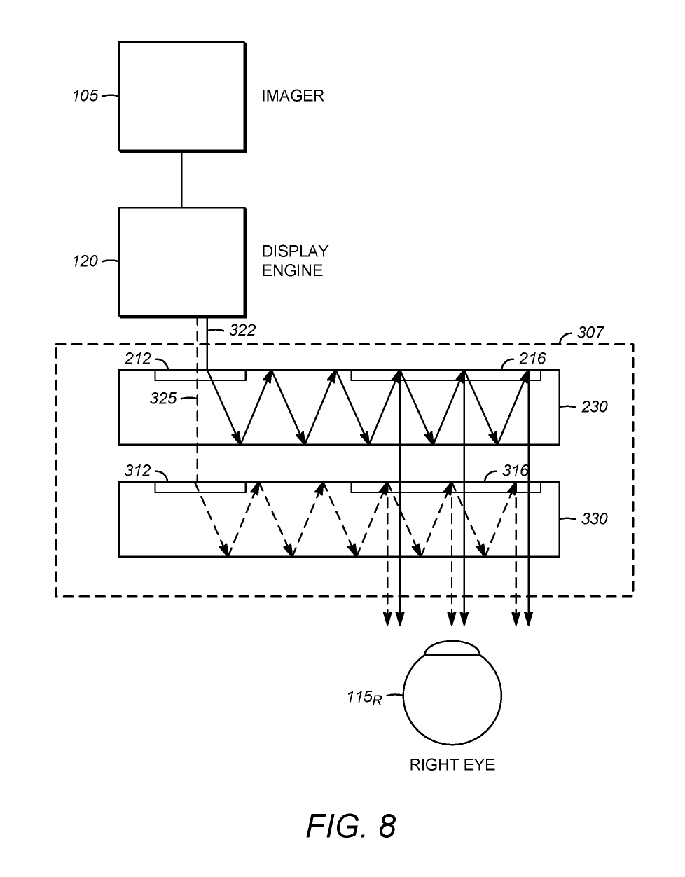

FIG. 8 illustrates the operation of the EPE 307 shown in FIG. 7. For clarity of illustration, only the rightmost portion of the waveguides 230 and 330 are shown, which direct light to the right eye 115R. The leftmost portion of the EPE operates in a similar fashion. In FIG. 8, the solid arrowed line 322 is representative of red and green light of the image that is output by the display engine 120 and the dashed arrowed line 325 is representative of blue and green light of the image that is output by the light engine 120.

When implemented as an input diffraction grating, the input coupler 212 is designed to diffract e.g., red, light within an input angular range (e.g., +/−15 degrees relative to the normal) into the waveguide plate 230, such that an angle of the diffractively in-coupled light exceeds the critical angle for the waveguide 230 and can thereby travel by way of TIR from the input coupler 212 to the output coupler 216. Further, the input coupler 212 is designed to transmit light outside the wavelength range that is diffracted so that light outside this wavelength range will pass through the waveguide plate 230. However, note that for the waveguide plates in the waveguide stack of FIG. 8 there may be some of amount of cross-coupling between the waveguides. Likewise, output coupler 216 outputs e.g., red light for viewing by the eye 115R.

Similarly, when implemented as an input diffraction grating, the input coupler 312 is designed to diffract e.g., blue and green light within an input angular range (e.g., +/−15 degrees relative to the normal) into the waveguide plate 330, such that an angle of the diffractively in-coupled blue and green light exceeds the critical angle for the waveguide plate 330 and can thereby travel by way of TIR from the input coupler 312 to the output coupler 316. Further, the input coupler 312 is designed to transmit light outside the e.g., blue and green wavelength ranges, so that light outside the blue and green wavelength ranges will pass through the waveguide plate 330. Likewise, output coupler 316 outputs blue and green light for viewing by the eye 214.

More generally, each of the waveguide plates can include an input coupler that is configured to couple-in light within an input angular range (e.g., +/−15 degrees relative to the normal) and within a specific wavelength range into the waveguide plate, such that an angle of the in-coupled light exceeds the critical angle for the waveguide plate and can thereby travel by way of TIR from the input coupler to the output coupler of the waveguide, and such that light outside the specific wavelength range is transmitted and passes through the waveguide plate.

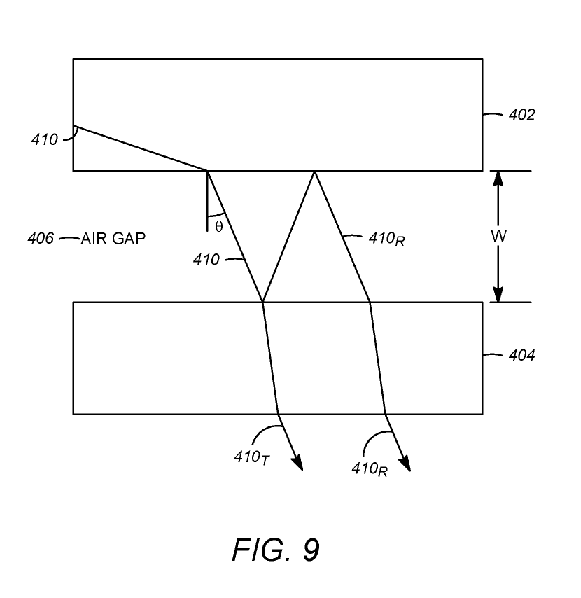

In the EPE shown in FIGS. 7 and 8 the waveguide plates in the waveguide display are parallel to one another. One problem that can arise in such an arrangement is that reflections between the waveguide plates at the air/waveguide interface produce interference fringes that degrade image quality. This problem is illustrated with reference to the two waveguide plates shown in FIG. 9. For simplicity, only the waveguide substrates 402 and 404 of the waveguide plates are illustrated and not the input and output couplers.

In FIG. 9 a light beam 410 enters and exits the first waveguide substrate 402 at an angle Θ so that it is transmitted across the air gap 406 and is incident upon the second waveguide substrate 404. At the air/glass interface between the air gap 406 and the second waveguide substrate 404 one portion of the light beam 410T is refracted and transmitted through the second waveguide substrate 404 (via input and output couplers) and another portion of the light beam 410R is reflected back to the first waveguide substrate 402, where it is again reflected at the air/glass interface between the air gap 406 and the first waveguide substrate 402 so that it is also refracted and transmitted through the second waveguide substrate 404. As a consequence, the light beams 410T and 410R output from the second waveguide substrate 404 interfere with one another, thereby producing interference fringes.

The path difference ΔW traveled by the light beam 410R relative to the light beam 410T for an air gap having a width W is:

ΔW=2W/cos(θ)−2W·sin θ/(cos θ)sin θ=2W·cos(θ)

The transmission efficiency T is:

T airgap=T²1+R²+2T²R·cos(2π·nΔL/λ)+ . . .

Where R is the reflectivity of the waveguide substrates.

The transmission efficiency thus depends on the angle at which the light beam 410 exits the waveguide substrate 402.

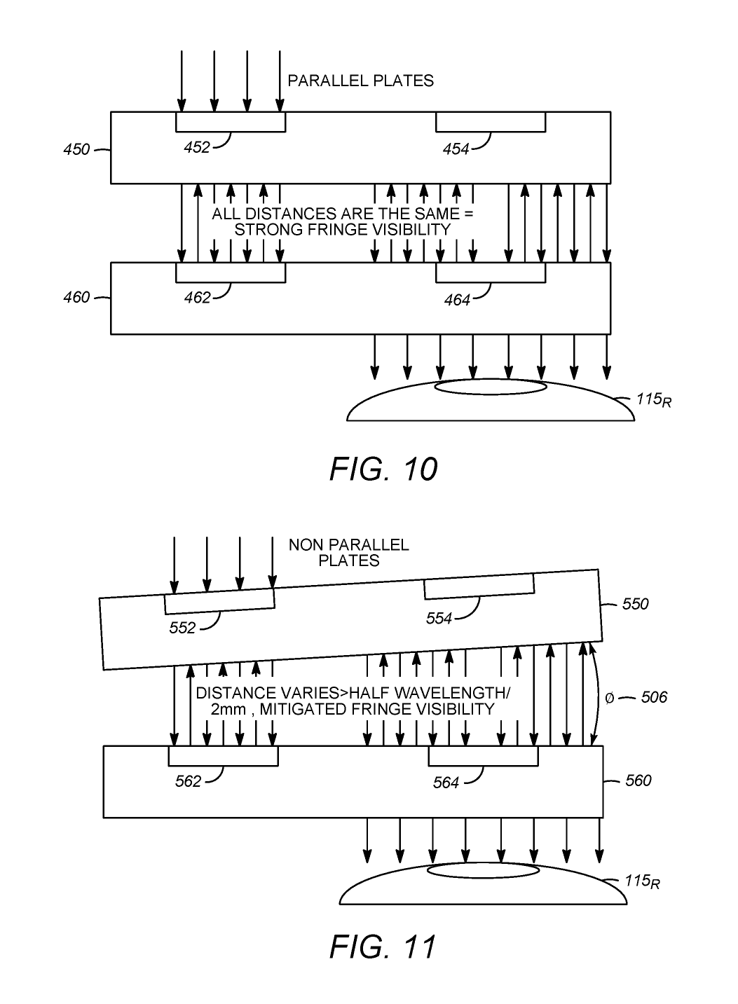

While anti-reflective coatings may be applied to the waveguide plate surfaces to mitigate this problem, it is difficult to form the coating on the DOEs. Likewise, while a larger air gap may be applied to reduce the interference fringes, the coherence length of the light source is at most several hundreds of microns and thus a large air gap (e.g., greater than 0.5 mm) results in a device that is no longer practical. An alternative solution to this problem is illustrated with reference to FIGS. 10 and 11, which, similar to FIG. 8, only show the rightmost portion of the two waveguide plates.

FIG. 10 shows the waveguide plates 450 and 460, which are parallel to one another. Waveguide plate 450 includes input coupler 452 and the rightmost output coupler 454. Waveguide plate 460 includes input coupler 462 and the rightmost output coupler 464. Because the waveguide plates 450 and 460 are parallel, all the light beams entering the eye traverse the same path length in the air gap. As a consequence, fringes are produced as the transmission varies between its maximum value (due to constructive interference) and its minimum value (due to destructive interference).

FIG. 11 shows the waveguide plates 550 and 560, which are non-parallel to one another so that air gap 506 is wedge-shaped width such that its width W increases along its length. Waveguide plate 550 includes input coupler 552 and the rightmost output coupler 554. Waveguide plate 560 includes input coupler 562 and the rightmost output coupler 564. Because the waveguide plates 550 and 560 are non-parallel, the different light beams traverse different path lengths in the air gap. Thus, parts of the light beams undergo constructive interference and other parts undergo deconstructive interference, with the amount of interference varying between these two extremes in different parts. As a consequence the visibility of interference fringes is reduced.

In accordance with some embodiments, the waveguide plates 550 and 560 shown in FIG. 11 may have a thickness of about 600 microns and the air gap 506 between them may have a width in the range of 50-300 microns. The wedge angle φ defining the degree to which the waveguide plates 550 and 560 are no longer parallel may range between about 0.5-5.0 arcmins and more particularly in some embodiments between 20-300 arcsecs.

If the waveguide display includes more than two waveguide plates, each of them may be arranged so that they are non-parallel to the others in the same manner as shown for the two waveguide plates in FIG. 11.

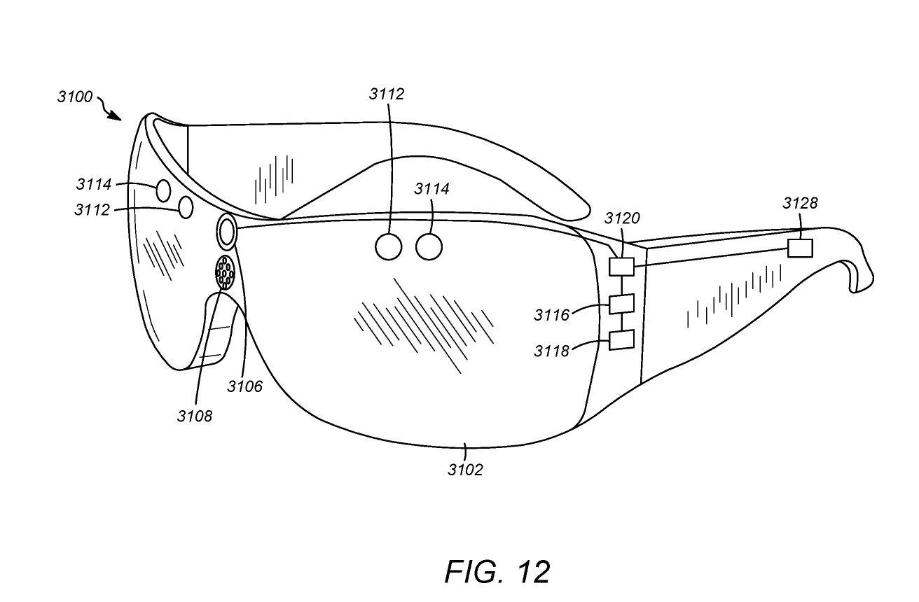

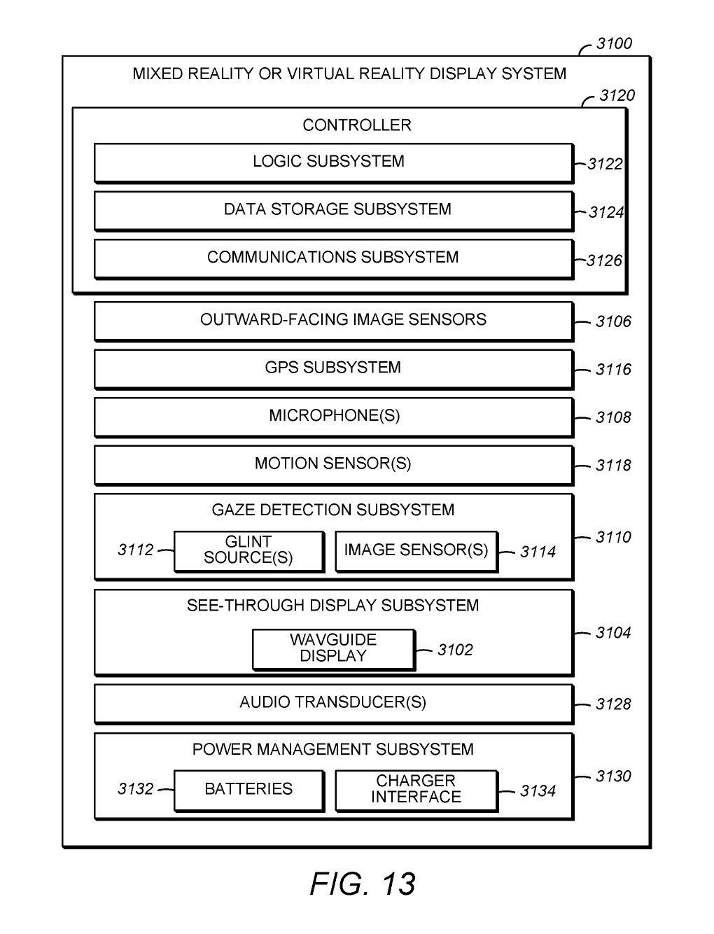

Embodiments of the waveguide display described above may be utilized in mixed-reality or virtual-reality applications. FIG. 12 shows one particular illustrative example of a mixed-reality or virtual-reality HMD device 3100, and FIG. 13 shows a functional block diagram of the device 3100. HMD device 3100 comprises one or more waveguide displays 3102 that form a part of a see-through display subsystem 3104, so that images may be displayed. HMD device 3100 further comprises one or more outward-facing image sensors 3106 configured to acquire images of a background scene and/or physical environment being viewed by a user, and may include one or more microphones 3108 configured to detect sounds, such as voice commands from a user. Outward-facing image sensors 3106 may include one or more depth sensors and/or one or more two-dimensional image sensors. In alternative arrangements, as noted above, a mixed reality or virtual reality display system, instead of incorporating a see-through display subsystem, may display mixed reality or virtual reality images through a viewfinder mode for an outward-facing image sensor.

The HMD device 3100 may further include a gaze detection subsystem 3110 configured for detecting a direction of gaze of each eye of a user or a direction or location of focus, as described above. Gaze detection subsystem 3110 may be configured to determine gaze directions of each of a user's eyes in any suitable manner. For example, in the illustrative example shown, a gaze detection subsystem 3110 includes one or more glint sources 3112, such as infrared light sources, that are configured to cause a glint of light to reflect from each eye of a user, and one or more image sensors 3114, such as inward-facing sensors, that are configured to capture an image of each eyeball of the user. Changes in the glints from the user's eye and/or a location of a user's pupil, as determined from image data gathered using the image sensor(s) 3114, may be used to determine a direction of gaze.

In addition, a location at which gaze lines projected from the user's eyes intersect the external display may be used to determine an object at which the user is gazing (e.g. a displayed virtual object and/or real background object). Gaze detection subsystem 3110 may have any suitable number and arrangement of light sources and image sensors. In some implementations, the gaze detection subsystem 3110 may be omitted.

The HMD device 3100 may also include additional sensors. For example, HMD device 3100 may comprise a global positioning system (GPS) subsystem 3116 to allow a location of the HMD device 3100 to be determined. This may help to identify real-world objects, such as buildings, etc. that may be located in the user's adjoining physical environment. The HMD device 3100 may further include one or more motion sensors 3118 (e.g., inertial, multi-axis gyroscopic, or acceleration sensors) to detect movement and position/orientation/pose of a user's head when the user is wearing the system as part of a mixed reality or virtual reality HMD device. Motion data may be used, potentially along with eye-tracking glint data and outward-facing image data, for gaze detection, as well as for image stabilization to help correct for blur in images from the outward-facing image sensor(s) 3106. The use of motion data may allow changes in gaze direction to be tracked even if image data from outward-facing image sensor(s) 3106 cannot be resolved.

In addition, motion sensors 3118, as well as microphone(s) 3108 and gaze detection subsystem 3110, also may be employed as user input devices, such that a user may interact with the HMD device 3100 via gestures of the eye, neck and/or head, as well as via verbal commands in some cases. It may be understood that sensors illustrated in FIGS. 31 and 32 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The HMD device 3100 can further include a controller 3120 such as one or more processors having a logic subsystem 3122 and a data storage subsystem 3124 in communication with the sensors, gaze detection subsystem 3110, display subsystem 3104, and/or other components through a communications subsystem 3126. The communications subsystem 3126 can also facilitate the display system being operated in conjunction with remotely located resources, such as processing, storage, power, data, and services. That is, in some implementations, an HMD device can be operated as part of a system that can distribute resources and capabilities among different components and subsystems.

The storage subsystem 3124 may include instructions stored thereon that are executable by logic subsystem 3122, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The HMD device 3100 is configured with one or more audio transducers 3128 (e.g., speakers, earphones, etc.) so that audio can be utilized as part of a mixed reality or virtual reality experience. A power management subsystem 3130 may include one or more batteries 3132 and/or protection circuit modules (PCMs) and an associated charger interface 3134 and/or remote power interface for supplying power to components in the HMD device 3100.

It may be appreciated that the HMD device 3100 is described for the purpose of example, and thus is not meant to be limiting. It may be further understood that the display device may include additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

Various exemplary embodiments of the present display system are now presented by way of illustration and not as an exhaustive list of all embodiments. An example includes a see-through, near eye display system, comprising: an imager for providing an output image; an exit pupil expander (EPE); a display engine for coupling the output image from the imager into the EPE, the EPE including at least first and second waveguide plates, each of the waveguide plates including a substrate having an input coupling diffractive optical element (DOE) for in-coupling image light of a range of wavelengths to the substrate and transmitting other wavelengths of image light and at least one output coupling DOE for out-coupling image light of the range of wavelengths from the substrate, the range of wavelengths of the image light for each of the waveguide plates differing at least in part from each of the other waveguide plates, the first and second waveguide plates having an air gap therebetween, the air gap having a length and width such that the width varies along the length.

In another example, the range of wavelengths of the image light for the first and second waveguide plates are non-overlapping. In another example, the range of wavelengths of the image light for the first waveguide plate and the second waveguide plate are overlapping in part. In another example, the output coupling DOE for each of the waveguide plates include a plurality of output coupling DOEs. In another example, the imager is selected from one of a laser, laser diode, light emitting diode, liquid crystal on silicon device and an organic light emitting diode array. In another example, the waveguide plates are planar. In another example, a wedge angle between the two waveguide plates is between 20-300 arsecs. A further example includes a waveguide display, comprising: at least first and second waveguide substrates separated by an air gap and nonparallel to one another; first and second input couplers for coupling light into first and second waveguide substrates, respectively, the first input coupler being configured to in-couple a first range of wavelengths into the first substrate and transmit other wavelengths and the second input coupler being configured to in-couple a second range of wavelengths into the second substrate and transmit other wavelengths; at least first and second output couplers for coupling light out of the first and second waveguide substrates, respectively, the first output coupler being configured to out-couple the first range of wavelengths from the first substrate and the second output coupler being configured to out-couple the second range of wavelengths from the second substrate.

In another example, the waveguide display is configured as a near-eye optical display. In another example, the first and second input couplers are DOEs. In another example, the first and second output couplers are DOEs. In another example, the first output coupler comprises a pair of output couplers for stereoscopic viewing and the second output coupler comprises a pair of output couplers for stereoscopic viewing. In another example, the first and second range of wavelengths are overlapping.

A further example includes a head mounted display comprising: a head mounted retention system for wearing on a head of a user; a visor assembly secured to the head mounted retention system, the visor assembly including a chassis; a near-eye optical display system secured to the chassis that includes a waveguide display, the waveguide display including: at least first and second waveguide plates, each of the waveguide plates including a substrate having an input coupling diffractive optical element (DOE) for in-coupling image light of a range of wavelengths to the substrate and transmitting other wavelengths of image light and at least one output coupling DOE for out-coupling image light of the range of wavelengths from the substrate, the range of wavelengths of the image light for each of the waveguide plates differing at least in part from each of the other waveguide plates, the first and second waveguide plates having an air gap therebetween, the air gap having a thickness that varies across an area of the air gap.

In another example, the range of wavelengths of the image light for the first and second waveguide plates are non-overlapping. In another example, the range of wavelengths of the image light for the first waveguide plate encompasses wavelengths corresponding to red and green light and the range of wavelengths of the image light for the second waveguide plate correspond to blue and green light. In another example, the waveguide plates are planar. In another example, a wedge angle between the two waveguide plates is between 0.5-5.0 arcmins. In another example, at least four waveguide plates are included, the air gap having a varying width being located between any two of the waveguide plates.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A see-through, near eye display system, comprising:
an imager for providing an output image;
an exit pupil expander (EPE);
a display engine for coupling the output image from the imager into the EPE, the EPE including at least first and second waveguide plates, each of the waveguide plates including a substrate having an input coupling diffractive optical element (DOE) for in-coupling image light of a range of wavelengths to the substrate and transmitting other wavelengths of image light and at least one output coupling DOE for out-coupling image light of the range of wavelengths from the substrate, the range of wavelengths of the image light for each of the waveguide plates differing at least in part from each of the other waveguide plates, the first and second waveguide plates having an air gap therebetween, the air gap having a length and width such that the width varies along the length.

2. The see-through, near eye display system of claim 1 wherein the range of wavelengths of the image light for the first and second waveguide plates are non-overlapping.

3. The see-through, near eye display system of claim 1 wherein the range of wavelengths of the image light for the first waveguide plate and for the second waveguide plate overlap in part.

4. The see-through, near eye display system of claim 1 wherein the output coupling DOE for each of the waveguide plates include a plurality of output coupling DOEs.

5. The see-through, near eye display system of claim 1 wherein the imager is selected from one of a laser, laser diode, light emitting diode, liquid crystal on silicon device and an organic light emitting diode array.

6. The see-through, near eye display system of claim 1 wherein the waveguide plates are planar.

7. The see-through, near eye display system of claim 1 wherein a wedge angle between the two waveguide plates is between 20 and 300 arcsecs.

8. A waveguide display, comprising:
at least first and second waveguide substrates separated by an air gap and nonparallel to one another;
first and second input couplers for coupling light into first and second waveguide substrates, respectively, the first input coupler being configured to in-couple a first range of wavelengths into the first substrate and transmit other wavelengths and the second input coupler being configured to in-couple a second range of wavelengths into the second substrate and transmit other wavelengths;
at least first and second output couplers for coupling light out of the first and second waveguide substrates, respectively, the first output coupler being configured to out-couple the first range of wavelengths from the first substrate and the second output coupler being configured to out-couple the second range of wavelengths from the second substrate.

9. The waveguide display of claim 8 wherein the waveguide display is configured as a near-eye optical display.

10. The waveguide display of claim 8 wherein the first and second input couplers are DOEs.

11. The waveguide display of claim 8 wherein the first and second output couplers are DOEs.

12. The waveguide display of claim 8 wherein the first output coupler comprises a pair of output couplers for stereoscopic viewing and the second output coupler comprises a pair of output couplers for stereoscopic viewing.

13. The waveguide display of claim 8 wherein the first and second range of wavelengths are non-overlapping.

14. The waveguide display of claim 8 wherein the first and second range of wavelengths are overlapping.

15. The waveguide display of claim 8 wherein the first range of wavelengths and the second range of wavelengths are nonoverlapping.

16. A head mounted display comprising:
a head mounted retention system for wearing on a head of a user;
a visor assembly secured to the head mounted retention system, the visor assembly including a chassis;
a near-eye optical display system secured to the chassis that includes a waveguide display, the waveguide display including:
at least first and second waveguide plates, each of the waveguide plates including a substrate having an input coupling diffractive optical element (DOE) for in-coupling image light of a range of wavelengths to the substrate and transmitting other wavelengths of image light and at least one output coupling DOE for out-coupling image light of the range of wavelengths from the substrate, the range of wavelengths of the image light for each of the waveguide plates differing at least in part from each of the other waveguide plates, the first and second waveguide plates having an air gap therebetween, the air gap having a thickness that varies across an area of the air gap.

17. The head-mounted display of claim 16 wherein the range of wavelengths of the image light for the first and second waveguide plates are non-overlapping.

18. The head-mounted display of claim 16 wherein the at least first and second waveguide plates comprise at least four waveguide plates, the air gap having a varying width being located between any two of the waveguide plates.

19. The head-mounted display of claim 16 wherein the waveguide plates are planar.

20. The head-mounted display of claim 16 wherein a wedge angle between the two waveguide plates is greater than 20 arcsecs.
